(19) United States
(12) Patent Application Publication
(10) Pub. No.: US 2004/0125018 A1
(43) Pub. Date: Jul. 1, 2004

(54) Multiband compressed antenna in a volume

(76) Inventors: Suresh Kumar Ramasamy, Redwood City, CA (US); Eduardo Camacho Lopez, Watsonville, CA (US); Robert Paul Garcia, San Jose, CA (US); Anhtho Hoang Pham, San Jose, CA (US)

Correspondence Address: David E. Lovejoy, 102 Reed Ranch Road, Tiburon, CA, 94920-2025, US

(21) Appl. No.: 10/330,377

(22) Filed: Dec. 27, 2002

(51) Int. Cl. H01Q 1/38

(52) U.S. Cl. 343/700 MS; 343/895; 343/702; 343/741; 343/866

(57) ABSTRACT

A compressed antenna in a volume suitable for use in the front ends of small communications devices. The compressed antenna operates for exchanging energy in one or more bands of radiation frequencies. The antenna includes one or more radiation elements formed of segments electrically connected so as to exchange energy in one or more of the bands of the radiation frequencies. The radiation element has segments three-dimensionally arrayed and compressed in a volume.

### BACKGROUND OF THE INVENTION

The present invention relates to the field of communication devices that communicate using radiation of electromagnetic energy and particularly relates to antennas and radio frequency (RF) front ends for such communication devices, particularly antennas for small communication devices carried by persons or communication devices otherwise benefitting from small-sized antennas and small-sized front ends.

Small communication devices include front-end components connected to base-band components (base components). The front-end components operate at RF frequencies and the base components operate at intermediate frequencies (IF) or other frequencies lower than RF frequencies. The RF front-end components for small devices have proved to be difficult to design, difficult to miniaturize and have added significant costs to small communication devices. The size of the antenna and its connection to the other RF components is critical in the quest for reducing the size of communication devices.

Communication devices that both transmit and receive with different transmit and receive bands typically use filters (duplexers, diplexers) to isolate the transmit and receive bands. Such communication devices typically employ broadband antennas that operate over frequency bands that are wider than the operating bands of interest and therefore the filters used to separate the receive (Rx) band and the transmit (Tx) band of a communication device operate to constrain the bandwidth within the desired operating receive (Rx) and the transmit (Tx) frequency bands. A communication device using transmit and receive bands for two-way communication is often referred to as a “single-band” communication device since the transmit and receive bands are usually close to each other within the frequency spectrum and are paired or otherwise related to each other for a common transmit/receive protocol. Dual-band communication devices use two pairs of transmit and receive bands, each pair for two-way communication. In multi-band communication devices, multiple pairs of transmit and receive bands are employed, each pair for two-way communication. In dual-band and other multi-band communication devices, additional filters are needed to separate the multiple bands and in addition, filters are also required to separate transmit and receive signals within each of the multiple bands. In standard designs, a Low Noise Amplifier (LNA) is included between the antenna and a mixer. The mixer converts between RF frequencies of the front-end components and lower frequencies of the base components.

The common frequency bands presently employed are US Cell, GSM 900, GSM 1800, GSM1900(PCS) where the frequency ranges are as follows:

| | Frequency Ranges |
|---|---|
| US Cell | 824-894 MHz |
| GSM 900 | 890-960 MHz |
| GSM 1800 | 1710-1880 MHz |
| GSM 1900 (PCS) | 1850-1990 MHz |

Communication Antennas Generally. In communication devices and other electronic devices, antennas are elements having the primary function of transferring energy to (in the receive mode) or from (in the transmit mode) the electronic device through radiation. Energy is transferred from the electronic device (in the transmit mode) into space or is transferred (in the receive mode) from space into the electronic device. A transmitting antenna is a structure that forms a transition between guided waves contained within the electronic device and space waves traveling in space external to the electronic device. The receiving antenna forms a transition between space waves traveling external to the electronic device and guided waves contained within the electronic device. Often the same antenna operates both to receive and transmit radiation energy.

Frequencies at which antennas radiate are resonant frequencies for the antenna. A resonant frequency, f, of an antenna can have many different values as a function, for example, of dielectric constant of material surrounding an antenna, the type of antenna, the geometry of the antenna and the speed of light.

In general, wave-length, λ, is given by λ=c/f=cT where c=velocity of light (=3×10⁸ meters/sec), f=frequency (cycles/sec), T=1/f=period (sec). Typically, the antenna dimensions such as antenna length, Aₗ, relate to the radiation wavelength A of the antenna. The electrical impedance properties of an antenna are allocated between a radiation resistance, Rᵣ, and an ohmic resistance, Rₒ. The higher the ratio of the radiation resistance, Rᵣ, to the ohmic resistance, Rₒ the greater the radiation efficiency of the antenna.

Antennas are frequently analyzed with respect to the near field and the far field where the far field is at locations of space points P where the amplitude relationships of the fields approach a fixed relationship and the relative angular distribution of the field becomes independent of the distance from the antenna.

Antenna Types. A number of different antenna types are well known and include, for example, loop antennas, small loop antennas, dipole antennas, stub antennas, conical antennas, helical antennas and spiral antennas. Such antenna types have often been based on simple geometric shapes. For example, antenna designs have been based on lines, planes, circles, triangles, squares, ellipses, rectangles, hemispheres and paraboloids. The two most basic types of electromagnetic field radiators are the magnetic dipole and the electric dipole. Small antennas, including loop antennas, often have the property that radiation resistance, Rᵣ, of the antenna decreases sharply when the antenna length is shortened.

An antenna radiates when the impedance of the antenna approaches being purely resistive (the reactive component approaches 0). Impedance is a complex number consisting of real resistance and imaginary reactance components. A matching network can be used to force resonance by eliminating reactive components of impedance for particular frequencies.

The RF front end of a communication device that operates to both transmit and receive signals includes antenna, filter, amplifier and mixer components that have a receiver path and a transmitter path. The receiver path operates to receive the radiation through the antenna. The antenna is matched at its output port to a standard impedance such as 50 ohms. The antenna captures the radiation signal from the air and transfers it as an electronic signal to a transmission line at the antennas output port. The electronic signal from the antenna enters the filter which has an input port that has also been matched to the standard impedance. The function of the filter is to remove unwanted interference and separate the receive signal from the transmit signal. The filter typically has an output port matched to the standard impedance. After the filter, the receive signal travels to a low noise amplifier (LNA) which similarly has input and output ports matched to the standard impedance, 50 ohms in the assumed example. The LNA boosts the signal to a level large enough so that other energy leaking into the transmission line will not significantly distort the receive signal. After the LNA, the receive signal is filtered with a high performance filter which has input and output ports matched to the standard impedance. After the high performance filter, the receive signal is converted to a lower frequency (intermediate frequency, IF) by a mixer which typically has an input port matched to the standard impedance.

The transmit path is much the same as the receive path. The lower frequency transmission signal from the base components is converted to an RF signal in the mixer and leaves the mixer which has a standard impedance output (for example, 50 ohms in the present example). The transmission signal from the mixer is “cleaned up” by a high performance filter which similarly has input and output ports matched to the standard impedance. The transmission signal is then buffered in a buffer amplifier and amplified in a power amplifier where the amplifiers are connected together with standard impedance lines, 50 ohms in the present example. The transmission signal is then connected to a filter, with input and output ports matched to the standard impedance. The filter functions to remove the remnant noise introduced by the receive signal. The filter output is matched to the standard impedance and connects to the antenna which has an input impedance matched to the standard impedance.

As described above, the antenna, filter, amplifier and mixer components that form the RF front end of a small communication device each have ports that are connected together from component port to component port to form a transmission path and a receive path. Each port of a component is sometimes called a junction. For a standard design, the junction properties of each component in the transmission path and in the receive path are matched to standard parameters at each junction, and specifically are matched to a standard junction impedance such as 50 ohms. In addition to impedance values, each junction is also definable by additional parameters including scattering matrix values and transmittance matrix values. The junction impedance values, scattering matrix values and transmittance matrix values are mathematically related so that measurement or other determination of one value allows the calculation of the others.

Typical front-end designs place constraints upon the physical junctions of each component and treat each component as a discrete entity which is designed in many respects independently of the designs of other components provided that the standard matching junction parameter values are maintained. While the discrete nature of components with standard junction parameters tends to simplify the design process, the design of each junction to satisfy standard parameter values (for example, 50 ohms junction impedance) places unwanted limitations upon the overall front-end design.

While many parameters may be tuned and optimized in RF front ends, the antenna is a critical part of the design. In order to miniaturize the RF front end, miniaturization of the antenna is important to achieve small size. In the prior applications entitled ARRAYED-SEGMENT LOOP ANTENNA (SC/Ser. No. 09/738,906) and LOOP ANTENNA WITH RADIATION AND REFERENCE LOOPS (SC/Ser. No. 09/815,928) assigned to the same assignee as the present application, compressed antennas were shown to render good performance with small sizes. Those antennas were compressed primarily on a two-dimensional basis by having multiple segments connected in snowflake, irregular and other compressed two-dimensional patterns. Some of those compressed antennas have relatively large “footprints,” that is, the size of the antennas on substrates, circuit boards or other planes is larger than is desired for high compression.

In consideration of the above background, there is a need for improved antennas having smaller “footprints” for miniaturizing the RF front ends of communication devices.

### SUMMARY

The present invention is a compressed antenna in a volume. The compressed antenna is suitable for use in the front ends of small communications devices. The compressed antenna operates for exchanging energy in one or more bands of radiation frequencies. The antenna includes one or more radiation elements formed of conducting segments electrically connected so as to exchange energy in one or more of the bands of the radiation frequencies. One or more of the radiation elements has segments three-dimensionally arrayed and compressed in a volume.

In one embodiment, the compressed antenna has the radiation elements deployed on a flexible substrate and the elements and the substrate are folded to fit within a volume.

In one embodiment, the antenna has radiation elements three-dimensionally arrayed in a volume and arrayed to form a three-dimensional loop.

In one embodiment, the antenna has radiation elements three-dimensionally arrayed in a volume and arrayed to form a stub.

In one embodiment, the radiation element includes one or more connection pads for electrical connection to RF components of the communication device where the connection pads are suitable for surface mounting to a circuit board.

The foregoing and other objects, features and advantages of the invention will be apparent from the following detailed description in conjunction with the drawings.

### BRIEF DESCRIPTION OF THE DRAWINGS

FIG. 1 depicts a schematic top view of one embodiment of an unfolded compressed antenna lying in a base plane deployed on a flexible substrate.

FIG. 2 depicts a schematic top view of the compressed antenna of FIG. 1 folded on lines into a volume.

FIG. 3 depicts a schematic front view of the compressed antenna of FIG. 1 folded into a volume as shown in FIG. 2.

FIG. 4 depicts a volume for containing the compressed antenna of FIG. 3.

FIG. 5 depicts a schematic top view of another embodiment of the unfolded compressed antenna deployed on a flexible substrate.

FIG. 6 depicts a schematic top view of an embodiment of an antenna having two radiating elements deployed on a flexible substrate for the US Cell Rx band.

FIG. 7 depicts an end view of the antennas of FIG. 5 and FIG. 6 folded and mounted on the end of a circuit board.

FIG. 8 depicts an isometric view of the antennas of FIG. 5 and FIG. 6 folded and mounted on the end of a circuit board.

FIG. 9 depicts a front view of the antenna of FIG. 5 folded and mounted on the end of a circuit board.

FIG. 10 depicts a sectional view of the antenna of FIG. 9 taken along the section line 10-10′.

FIG. 11 depicts a schematic top view of an embodiment of an unfolded compressed antenna lying in a base plane and deployed on a flexible substrate for the PCS Rx band.

FIG. 12 depicts a schematic front view of the antenna of FIG. 11 rolled for compression into a volume.

FIG. 13 depicts a schematic top view of an embodiment of an antenna lying in a base plane and deployed on a flexible substrate for the PCS Tx band.

FIG. 14 depicts a top view of a flip-top phone communication device using antennas in accordance with the present invention.

FIG. 15 depicts an end view of the communication device of FIG. 14 cut away to reveal the antennas.

FIG. 16 depicts a top view of the communication device of FIG. 14 cut away to reveal the antennas.

FIG. 17 depicts a top view of another communication device cut away to reveal the antennas inside.

FIG. 18 depicts an end sectional view of the communication device of FIG. 17 that reveals an antenna.

FIG. 19 depicts the frequency response of the antenna of FIG. 6 for the US Cell transmit Tₓ band.

FIG. 20 depicts the frequency response of the antenna of FIG. 5 for the US Cell receive Rₓ band.

FIG. 21 depicts the isolation versus frequency of the antennas of FIG. 5 and FIG. 6.

FIG. 22 depicts the VSWR of the antenna of FIG. 13 for the PCS receive Rₓ band.

FIG. 23 depicts the VSWR of the antenna of FIG., 1 for the PCS receive Rₓ band.

FIG. 24 depicts the isolation versus frequency of the antennas of FIG. 11 and FIG. 13.

FIG. 25 depicts a schematic view of a small communication device with RF front-end functions including a antenna/filter and other RF functions and lower frequency base components.

FIG. 26 depicts a schematic view of a small communication device with RF front-end functions including separate transmit and receive antennas and other RF function components and including lower frequency base components.

FIG. 27 depicts a schematic view of a dual-band small communication device with RF front-end functions, including integrated antenna/filter functions in separate filtennas for the transmit and receive paths in both bands, and including lower frequency base components.

FIG. 28 depicts a top view of unstacked layers, lying in a base plane, of another embodiment of an antenna.

FIG. 29 depicts a top view, a front view and a bottom view of the layers of FIG. 28 stacked together to form a compressed cube antenna in a volume.

FIG. 30 depicts a representation of a front view of a cellular phone representative of a small communication device employing the compressed antenna of FIG. 29.

FIG. 31 depicts a representation of an end view of the cellular phone of FIG. 30 taken along a section line 30′-30″ in FIG. 30.

### DETAILED DESCRIPTION

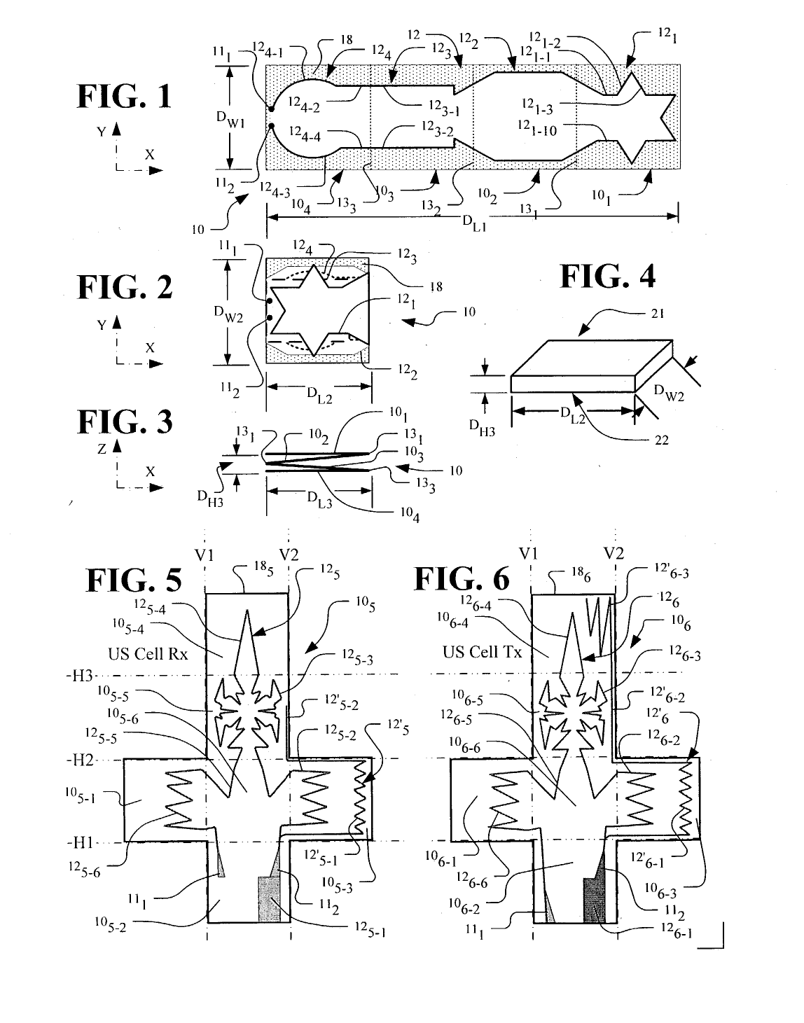

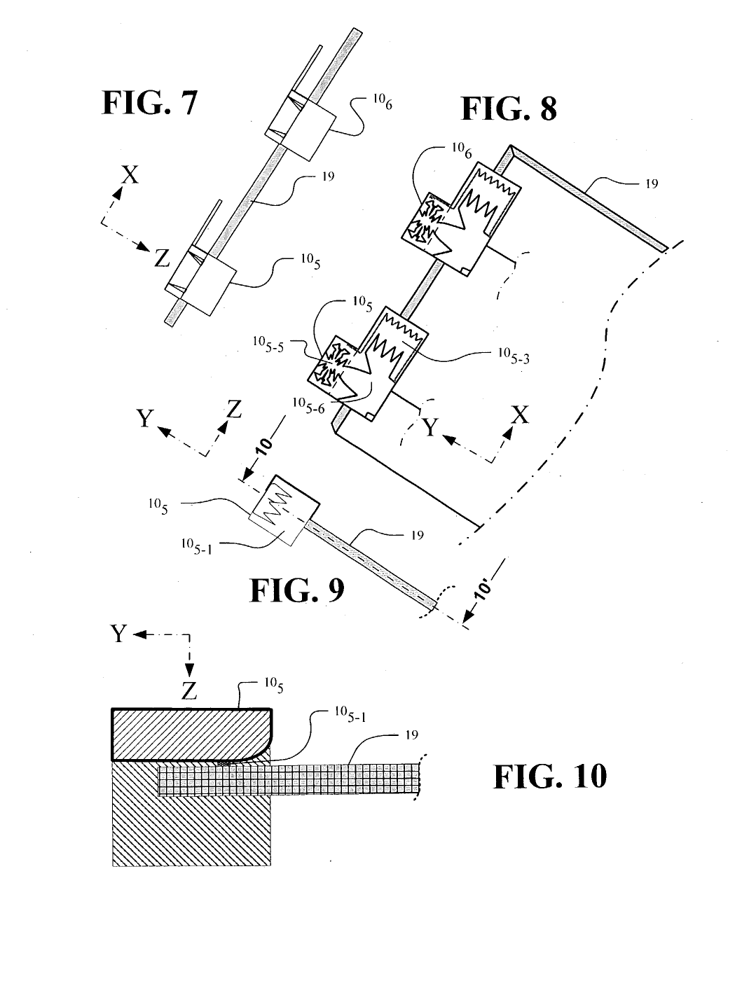

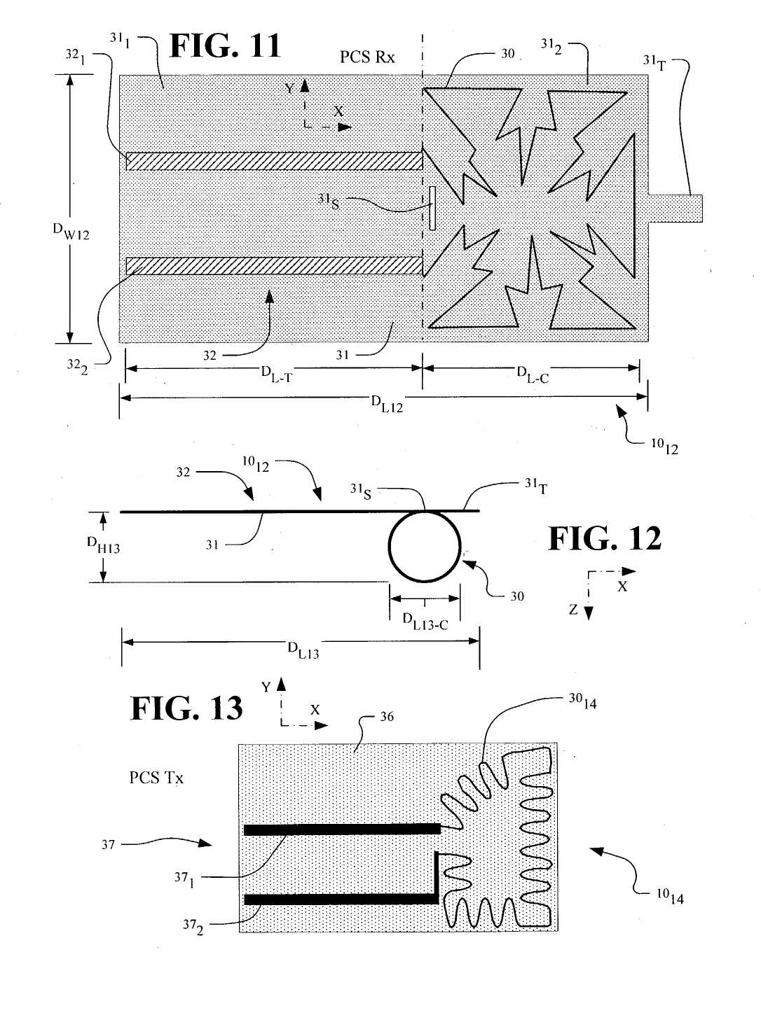

FIG. 1 depicts a schematic top view of one embodiment of an unfolded antenna 10 formed of a radiation element 12 lying in a base plane (the plane of the drawing) deployed on a flexible substrate 18. The antenna 10 is formed of regions 10₁, 10₂, 10₃ and 10₄ where region 10₁ connects to region 10₂, region 10₂ connects to region 10₃ and region 10₃ connects to region 10₄. The radiation element 12 is formed of sections 12₁, 12₂, 12₃ and 12₄, each formed of conducting segments, deployed in regions 10₁, 10₂, 10₃ and 10₄, respectively. The section 12, connects to section 12₂, section 12₂ connects to section 12₃ and section 12₃ connects to section 12₄. The section 12₄ terminates in termination end 11₁ and connection pad 11₂ that are fabricated on substrate 18. The radiation element 12 and sections 12₁, 12₂, 12₃ and 12₄ form a loop between termination end 11₁ and connection pad 11₂. The sections 12₁, 12₂, 12₃ and 12₄ are deployed on the substrate 18 in the regions 10₁, 10₂, 10₃ and 10₄, respectively. The overall outside dimensions, D_{W1} and D_{L1}, of the antenna 10 are approximately 10 mm and 26 mm, respectively. The radiation element 12 and substrate 18 are intended to be folded into a volume along the folding lines 13₁, 13₂ and 13₃.

FIG. 2 depicts a schematic top view of the antenna 10, including The radiation element 12 on substrate 18 as shown in FIG. 1, folded into a volume. The view in FIG. 2 is cutaway to show the sections 12₁, 12₂, 12₃ and 12₄ superimposed and terminating in the connection pads 11-1 and 11-2 at the bottom of the volume. In FIG. 2, the outside dimensions, D_{W2} and D_{L2}, of the antenna 10 are approximately 10 mm and 10 mm, respectively. Accordingly, the projection of the antenna onto a reference base plane (the plane of the drawing) at the bottom of the volume has been reduced from 10 mm×26 mm in FIG. 1 to 10 mm×10 mm in FIG. 2. In FIG. 2, the segments of section 12₃ are superimposed over the segments of section 12₁. The segments of section 12₂ are superimposed over the segments of section 12₃ and section 12₄. The segments of section 12₁ are superimposed over the segments of section 12₂, section 12₃ and section 12₄. By way of example and as shown in FIG. 1, section 12₁ includes conducting segments 12₁₋₁, 12₁₋₂, 12₁₋₃, . . . , 12₁₋₁₀. Similarly, section 12₃ includes conducting segments 12₃₋₁ and 12₃₋₂ among others. Also, section 12₄ includes segments 12₄₋₁, 12₄₋₂, 12₄₋₃ and 12₄₋₄. When antenna 10 is folded as in FIG. 2, the segments 12₁₋₁, 12₁₋₂, 12₁₋₃, . . . , 12₁₋₁₀ are superimposed over the segment 12₃₋₁ and 12₃₋₂ and over the segments 12₄₋₁, 12₄₋₂, 12₄₋₃ and 12₄₋₄ among others. Also, the projections onto the base plane of the segments 12₁₋₁, 12₁₋₂, 12₁₋₃, . . . , 12₁₋₁₀ and of the segments 12₃₋₁, and 12₃₋₂ overlap. In FIG. 2, the base plane is the region 10₄ supporting the section 12₄ and including segments 12₄₋₁, 12₄₋₂, 12₄₋₃ and 12₄₋₄.

FIG. 3 depicts a schematic front view of the antenna 10 of FIG. 1 compressed as shown in FIG. 2. The view of FIG. 3 shows the regions 10₁, 10₂, 10₃ and 10₄ folded along the folding lines 13₁, 13₂ and 13₃ of FIG. 1. The height of the antenna 10 above the base plane is D_{H3} so that the volume of antenna 10 is D_{W2}×D_{L3}×D_{H3} where D_{W2} equals D_{W1} and D_{L3} equals D_{L2}.

FIG. 4 depicts a volume 21 for containing the compressed antenna 10 of FIG. 3. The volume 21 measures D_{H3}×D_{L2}×D_{WZ}. In one embodiment, D_{W2} equals D_{L2} equals about 1 cm and D_{H3} is less than 1/2 cm. The volume 21 has a base plane 22 on the bottom which measures D_{L2}×D_{WZ}.

FIG. 5 depicts a schematic top view of another embodiment of an unfolded antenna 10₅ formed of radiation elements 12₅ and 12′₅ lying in a base plane (the plane of the drawing) deployed on a flexible substrate 18₅. The antenna 10₅ is formed of regions 10₅₋₁, 10₅₋₂, 10₅₋₃ 10₅₋₄, 10₅₋₅ and 10₅₋₆ partitioned by the H1, H2 and H3 horizontal reference lines and the V1 and V2 vertical reference lines. Regions 10₅₋₁, 10₅₋₂, 10₅₋₃ and 10₅₋₅ connect to region 10₅₋₆ and region 10₅₋₄ connects to region 10₅₋₅. The radiation element 12₅ is formed of several sections including sections 12₅₋₁, 12₅₋₂, 12₅₋₃, 12₅₋₄, 12₅₋₅ and 12₅₋₆, for example, each formed of conducting segments, deployed in regions 10₅₋₁, 10₅₋₂, 10₅₋₃, 10₅₋₄, 10₅₋₅ and 10₅₋₆. The section 125-6 connects to termination end 11₁ which is floating and has no external electrical connection. The section 12₅₋₂ connects to termination end 11₂ and connection pad 12₅₋₁. The connection pad 12₅₋₁ is provided for easy connection to a circuit board of a communication device.

In FIG. 5, the unfolded antenna 10₅ also includes a radiation element 12′₅ lying in the base plane (the plane of the drawing) deployed on the flexible substrate 18₅. The antenna radiation element 12′₅ is formed of several sections including sections 12′₅₋₁ and 12′₅₋₂ each formed of conducting segments deployed in regions 10₅₋₃ and 10₅₋₅, respectively. The section 12′₅₋₁ connects to termination end 11₂ and connection pad 12₅₋₁ and hence the radiation element 12′₅ is connected in common to the radiation element 12₅ at connection pad 12₅₋₁. The connection pad 12₅₋₁ provides for easy connection of both radiation element 12₅ and radiation element 12′₅ to a circuit board of a communication device. The end of section 12′₅₋₂ is floating and has no external electrical connection.

The radiation elements 12₅ and 12′₅ and the substrate 18₅ are intended to be folded along the H1, H2 and H3 horizontal reference lines and the V1 vertical reference line. When folded, the antenna 10₅ is compressed and contained within a volume. The antenna 10₅ when compressed by folding was found to work well in the US Cell receive band.

FIG. 6 depicts a schematic top view of another embodiment of an unfolded antenna 10₆ formed of radiation elements 12₆ and 12′₆ lying in a base plane (the plane of the drawing) deployed on a flexible substrate 18₆. The antenna 10₆ is formed of regions 10₆₋₁, 10₆₋₂, 10₆₋₃, 10₆₋₄, 10₆₋₅ and 10₆₋₆ partitioned by the H1, H2 and H3 horizontal reference lines and the V1 and V2 vertical reference lines. Regions 10₆₋₁, 10₆₋₂, 10₆₋₃ and 10₆₋₅ connect to region 10₆₋₆ and region 10₆₋₄ connects to region 10₆₋₅. The radiation element 12₆ is a radiation element formed of several sections including sections 12₆₋₁, 12₆₋₂, 12₆₋₃, 12₆₋₄, 12₆₋₅ and 12₆₋₆, for example, each formed of conducting segments, deployed in regions 10₆₋₁, 10₅₋₂, 10₆₋₃, 10₅₋₄, 10₆₋₅ and 10₆₋₆. The section 12₆₋₆ connects to termination end 11₁ which is floating and has no external electrical connection. The section 12₆₋₂ connects to termination end 11₂ and connection pad 12₆₋₁. The connection pad 12₆₋₁ is provided for easy connection to a circuit board of a communication device.

In FIG. 6, the unfolded antenna 10₆ also includes a radiation element 12′₆ lying in the base (the plane of the drawing) deployed on the flexible substrate 18₆. The antenna radiation element 12′₆ is formed of several sections including sections 12′₆₋₁, 12′₆₋₂ and 12′₆₋₃ each formed of conducting segments deployed in regions 10₆₋₃, 10₆₋₄ and 10₆₋₅. The section 12′₆₋₁ connects to termination end 11₂ and connection pad 12₆₋₁ and hence the radiation element 12′₅ is connected in common to the radiation element 12₆ at connection pad 12₆₋₁. The connection pad 12₆₋₁ provides for easy connection of both radiation element 12₆ and radiation element 12′₆ to a circuit board of a communication device. The end of section 12′₆₋₃ is floating and has no external electrical connection.

The radiation elements 12₆ and 12′₆ and the substrate 186 are intended to be folded along the H1, H2 and H3 horizontal reference lines and the V1 vertical reference line. When folded, the antenna 10₆ is compressed and contained within a volume. The antenna 10₆ when compressed by folding was found to work well in the US Cell transmit band.

FIG. 7 depicts an end view of the antennas 10₅ and 10₆ of FIG. 5 and FIG. 6 folded and mounted on the end of a circuit board 19.

FIG. 8 depicts an isometric view of the antennas 10₅ and 10₆ of FIG. 5 and FIG. 6 folded and mounted on the end of a circuit board 19. The regions 10₅₋₃ is not folded and lies in the same plane as region 10₅₋₆. The region 10₅₋₅ is folded normal to the plane of regions 10₅₋₃ and 10₅₋₆.

FIG. 9 depicts a front view of the antenna 10₅ of FIG. 5 folded and mounted on the end of a circuit board 19 with region 10₅₋₁ exposed.

FIG. 10 depicts a sectional view of the antenna 10₅ of FIG. 9 taken along the section line 10-10′ with a solder connection at connection pad 10₅₋₁.

FIG. 11 depicts a schematic top view of another embodiment of an unfolded antenna 10₁₂ having an irregular radiation element 30, formed of conducting segments, lying in a base plane and deployed on a flexible substrate 31. The substrate 31 is in two parts, one part 31₁ under the transmission line 32 and the other part 31₂ under the radiation element 30. The substrate 31 supports a transmission line 32, including parallel strips 32₁ and 32₂, connecting in series with the radiation element 30 with transmission line 32 so that radiation element 30 forms a loop antenna connected to a transmission line. The antenna 10₁₂ has overall outside dimensions, D_{W12} and D_{L12}, where the transmission line length is D_{L-TC} and the uncompressed antenna radiation element 30 length is D_{L-C}. The radiation element 30 and substrate 31₂ are intended to be rolled into a volume. The substrate 31 includes an extension 31_{T} for insertion into a slot 31_{S} when rolled up. The antenna 10₁₂ is designed for the US PCS receive band. Typically, the transmission 32 line is deployed directly on a printed circuit board of a communication device.

FIG. 12 depicts a schematic front view of the antenna 10₁₂ of FIG. 11 rolled-up (“folded”) into the compressed state. The antenna 10₁₂ in FIG. 12 has outside dimensions, D_{H13} and D_{L13}, where the compressed antenna radiation element 30 length is D_{L13-C}. The substrate 31 includes the extension 31_{T} inserted into the slot 31_{S}. The length of the radiation element 30, D_{L13-C}, in FIG. 12 is about one-third the uncompressed length D_{L-C} in FIG. 11 and hence compressing the antenna 10₁₂ by rolling into a volume reduces the projection the projection of the antenna 10₁₂ onto the base plane of the communication device.

FIG. 13 depicts a schematic top view of another embodiment of a compressed antenna 10₁₄ having an irregular radiation element 30₁₄, formed of conducting segments, lying in a plane and deployed on a substrate 36. The substrate 36 supports a transmission line 37, including parallel strips 37₁ and 37₂, connecting in series with the radiation element 30₁₄ so that radiation element 30₁₄ and transmission line 37 form a loop antenna connected to a transmission line. The antenna 10₁₄ is designed for the US PCS transmit band. In one embodiment, radiation element 30₁₄ is rolled up in the same manner described in connection with FIG. 12.

In FIG. 11 and FIG. 13, the radiating elements 30 and 30₁₄ are formed of segments arrayed in multiple divergent directions not parallel to an orthogonal coordinate system so as to provide a long antenna electrical length while permitting the overall outside dimensions of the antenna to fit within a small antenna volume. The segments of antenna 30 include segments 30-1, 30-2, . . . , 30-70. The segments of antenna 3014 include segments 30₁₄-1, 30₁₄-2, . . . , and so on. In FIG. 11 and FIG. 12, the radiation element 30 has an irregular shape and the segments 30-1, 30-2, . . . , 30-70 are arrayed in FIG. 12 in an irregular three-dimensional compressed pattern.

In FIG. 11, FIG. 12 and FIG. 13, the transmission lines 32 and 37 are part of the radiation elements and hence the lengths of the transmission lines 32 and 37 affect the frequency properties of the antennas. This attribute allows the antennas to be tuned by adjusting the length of the transmission lines 32 and 37. Typically, the transmission lines are adjusted to one third or more the length shown for tuning.

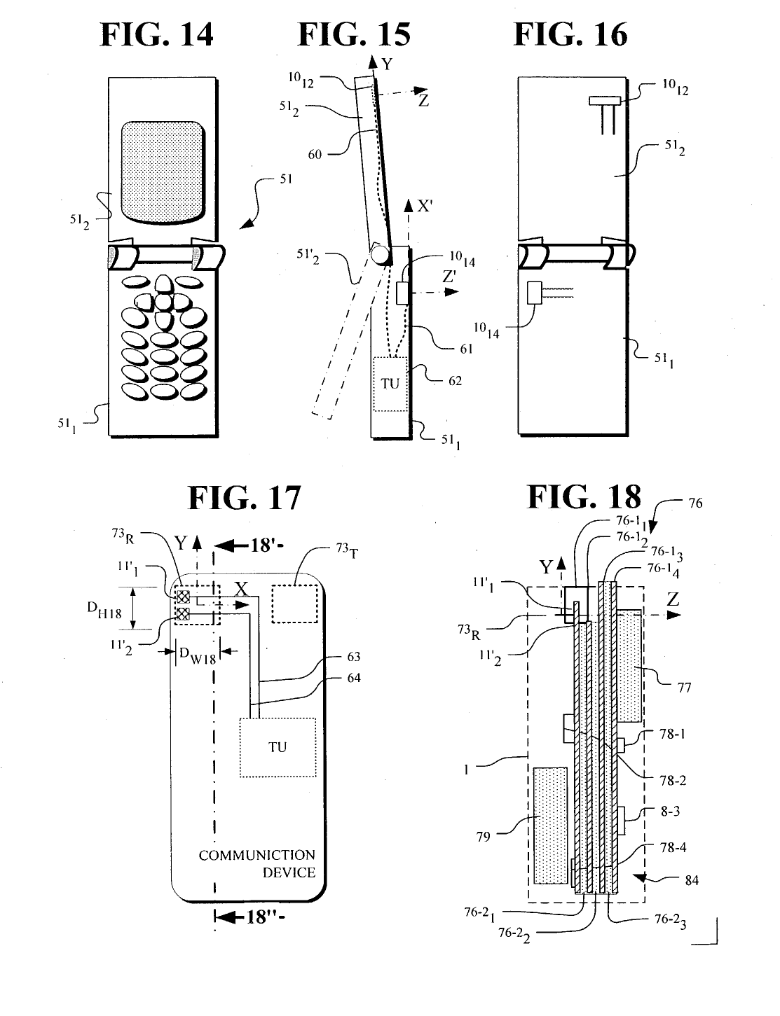

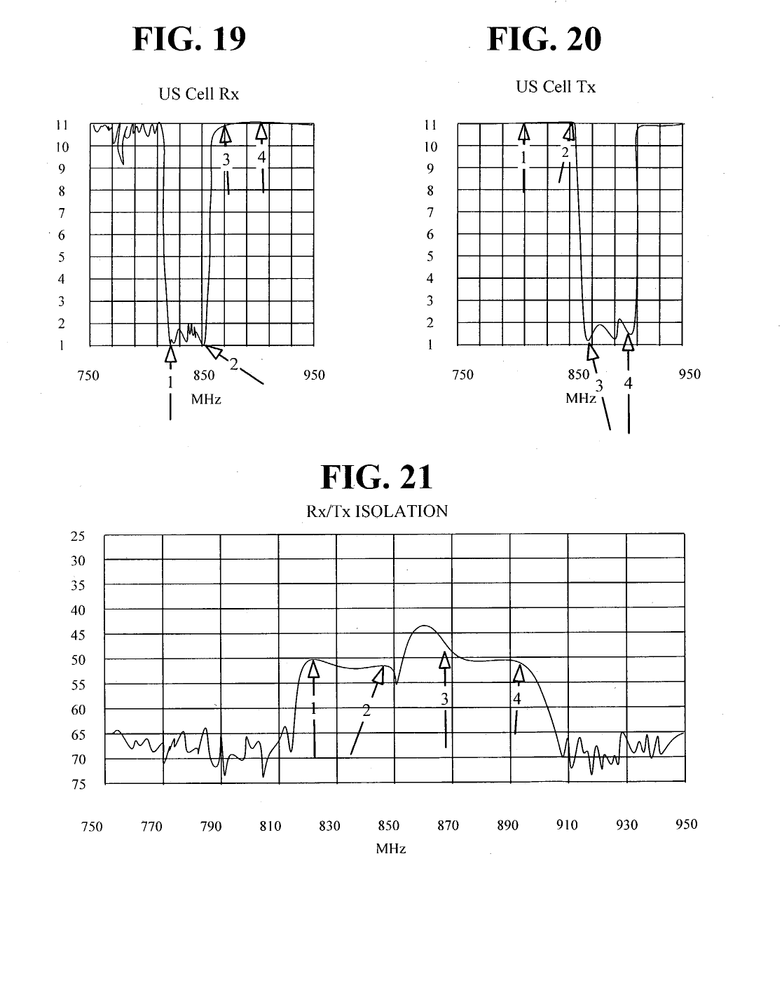

In FIG. 14, a top view is shown of communication device 51. The communication device 51 is a cell phone, pager or other similar communication device that can be used in close proximity to people with antennas of the present invention. The communication device 51 includes a flip portion 512 shown in the open position and includes a base portion 511. The communication device 51 includes antenna regions allocated for antennas like those shown in FIG. 11 and FIG. 13 (when rolled up to reduce the size as shown in FIG. 12), for example. Antennas are provided which receive and transmit. In one embodiment, the receive antenna is located in the base portion 511 and the transmit antenna is located in the flip portion 512. In FIG. 14, the antenna volumes are small so as to fit within the base and flip portions of the communication device 51.

In FIG. 15, the communication device 51 of FIG. 14 is shown in a partially-sectioned end view to reveal the compressed form of the internal antennas 10₁₂ and 10₁₄. The communication device 51 includes a flip portion 51₂ shown solid in the open position and shown as 51′₂ in broken-line representing a near-closed position. The antennas 10₁₂ and 10₁₄ are electrically connected by cables or other conductors 60 and 61, respectively, to the transceiver unit (TU) 62 which processes the transmit and receive signals for antennas 10₁₂ and 10₁₄.

In FIG. 16, the communication device 51 of FIG. 14 is shown in a partially-removed top view to reveal the antennas 10₁₂ and 10₁₄.

In FIG. 17, communication device 1 is a cell phone, pager or other similar communication device that can be used in close proximity to people with antennas of the present invention. The communication device 1 includes antenna areas allocated for antennas 73_{R} and 73_{T} which receive and transmit, respectively, radio wave radiation for the communication device 1. In FIG. 17, the antenna areas have widths D_{W18} and heights D_{H18}. The connection pads 11′₁ and 11′₂ are large enough to assist in registration using “pick and place” component mounting technology. A section line 6′-6″ extends from top to bottom of the communication device. The communication device 1 is typically a mobile telephone of small volume, for example, of approximately 4 inches by 2 inches by 1 inch, or smaller, and the antennas, such as described in the present invention, readily fit within such small volume.

In FIG. 17, the antenna 73_{R} is typically a compressed antenna that lies in an XYZ-volume. Such antennas operate in allocated frequency spectrums around the world including those of North America, South America, Europe, Asia and Australia. The cellular frequencies are used when the communication device 1 is a mobile phone, PDA, portable computer, telemetering equipment or other wireless device. The antennas operate to transmit and/or receive in allocated frequency bands, for example, bands within the range from 800 MHz to 2500 MHz. In FIG. 17, antenna 73_{R} includes connections 63 and 64 connecting from connection pads 11′₁ and 11′₂ to the transceiver unit 62 when loop antennas are employed. When only a single connection is employed for stub antenna operation, one of the connections 63 or 64 is eliminated.

In FIG. 18, the communication device 1 of FIG. 17 is shown in a schematic, cross-sectional, end view taken along the section line 18′-18″ of FIG. 17. In FIG. 18, a circuit board 76 includes, by way of example, an outer conducting layer 76-1₁, internal conducting layers 76-1₂ and 76-1₃, internal insulating layers 76-2₁, 76-2₂ and 76-2₃, and another outer conducting layer 76-1₄. In one example, the layer 76-1₁ is a ground plane and the layer 76-1₂ is a power supply plane. The printed circuit board 76 supports the electronic components associated with the communication device 1 including a display 77 and miscellaneous components 78-1, 78-2, 78-3 and 78-4 which are shown as typical. Communication device 1 also includes a battery 79. The antennas 73_{5R} and 73_{5T} are mounted or otherwise coupled to the printed circuit board 76 by solder or other convenient connection means.

FIG. 21 depicts a two-dimensional representation of the average field pattern of the antenna structure of FIG. 3 for the US PCS Rx band. The average is taken for the frequencies 1850 MHz, 1910 MHz and 1990 MHz, none of which have a large variance from the average.

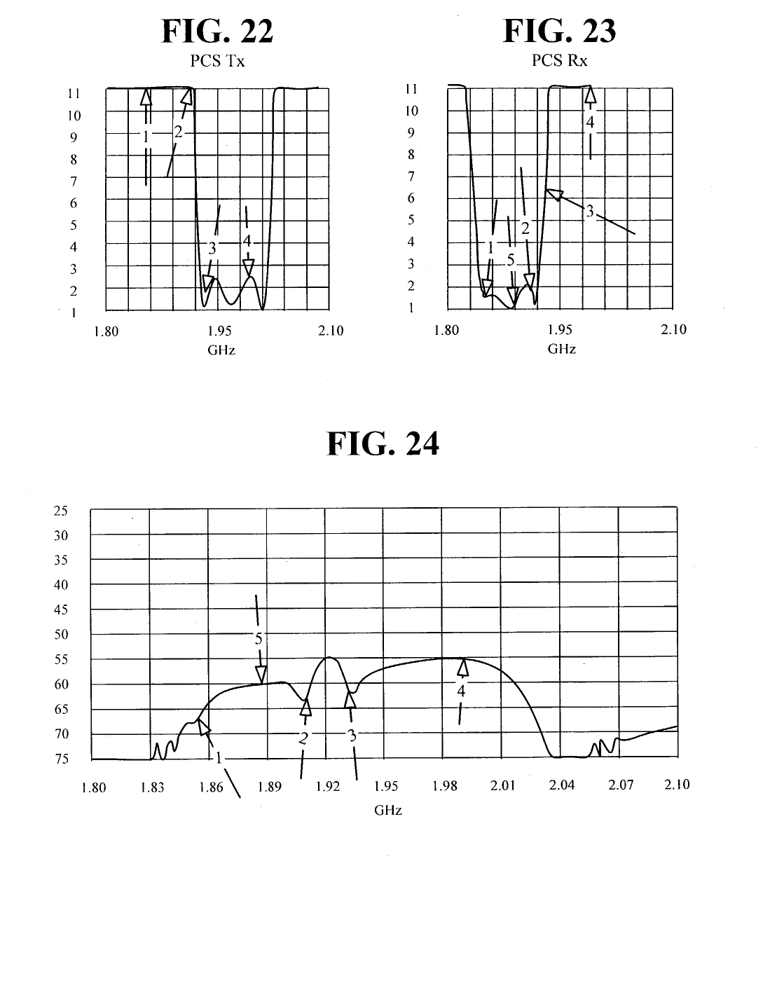

FIG. 22 depicts a two-dimensional representation of the average field pattern of the antenna structure of FIG. 13 for the US PCS Tx band. The average is taken for the frequencies 1850 MHz, 1910 MHz and 1990 MHz, none of which have a large variance from the average.

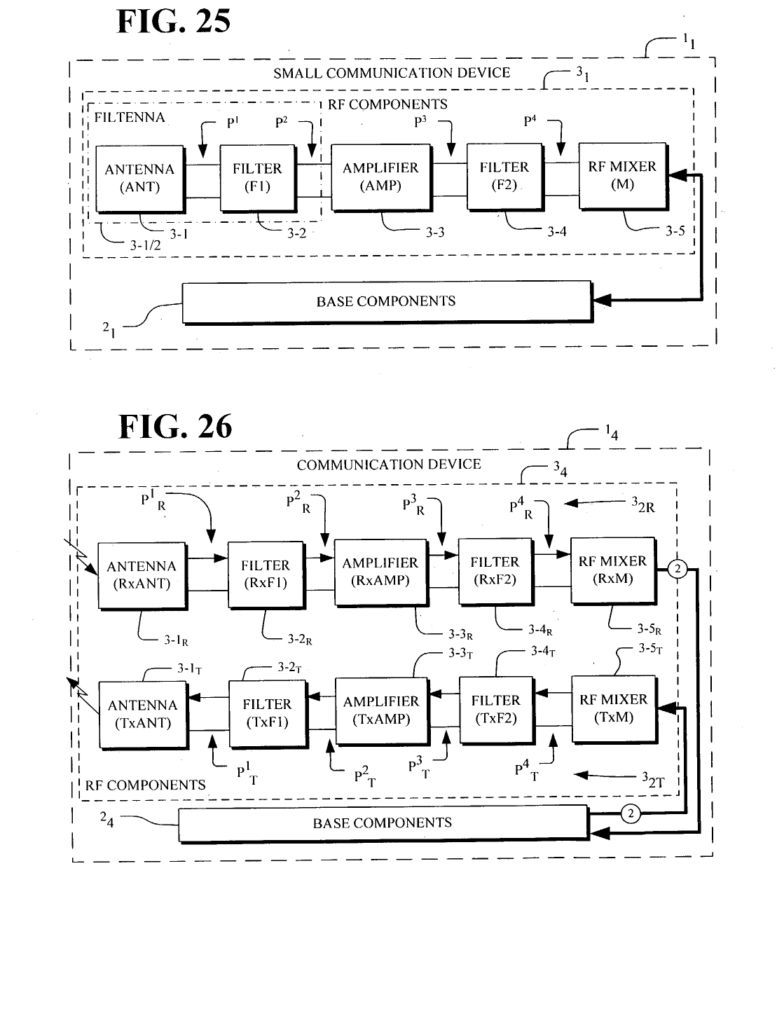

FIG. 25 depicts a schematic view of a small communication device 1₁ with RF front-end components 3₁ and base components 2₁. The RF components 3₁ perform the RF front-end functions that include an antenna function 3-1, a filter function 3-2, an amplifier function 3-3, a filter function 3-4 and a mixer function 3-5. The antenna function 3-1 is for converting between radiated and electronic signals, the filter function 3-2 is for limiting signals within operating frequency bands, the amplifier function 3-3 is for boosting signal power, the filter function 3-4 is for limiting signals within operating frequency bands, and the mixer function 3-5 is for shifting frequencies between RF and lower frequencies. The base components 2, perform lower frequency functions including intermediate-band and base-band processing necessary or useful for the communication device operation.

In FIG. 25, the RF front-end functions are connected by junctions where the junction P¹ is between antenna function 3-1 and filter function 3-2, where the junction P² is between filter function 3-2 and the amplifier function 3-3, where the junction P³ is between amplifier function 3-3 and filter junction 3-4 and where the junction P⁴ is between filter function 3-4 and mixer function 3-5. In the embodiment of FIG. 25, junctions P², P³ and P⁴ correspond to physical ports of physical filter, amplifier, filter and mixer components. The antenna function 3-1 and the filter function 3-2 are integrated so that the P¹ junction parameters are integrated and hence not separately considered. The junction parameter P² is tuned for the combined antenna function 3-1 and the filter function 3-2 in an integrated filter and antenna component 3-1/2. The integrated filter and antenna functions in integrated component (filtenna) 3-1/2 are characterized by the junction properties at junction P² while ignoring and not tuning the parameters at P¹. In particular, the junction impedance or other parameters at P¹ are not tuned to standard values, such as a 50 ohm matching impedance. The parameters at P¹ are “ignored” and assume values dependent on the tuned values for parameters at P². In this manner, the antenna and filter (filtenna) functions of integrated component 3-1/2 avoid the losses and other detriments attendant to matching the P¹ junction to standard values. For example, the filter function includes one or more additional filter poles in the filtenna integrated component, due to the contribution of the antenna, that cannot exist when the internal junction (P¹ in FIG. 25) is matched to a standard value. In this manner, the antenna function provides a resonator function that combines with a resonator functions of the filter.

FIG. 26 depicts a schematic view of a small communication device with RF front-end functions that benefit from antennas described in the present specification. The small communication device includes separate transmit and receive antennas, filters and other RF function components and lower frequency base components incorporating the antennas described in various embodiments. In FIG. 26, the small communication device 1₄ includes RF front-end components 3₄ and base components 2₄. The RF components perform the RF front-end functions and have both a receive path 3_{2R} and a transmit path 3_{2T} The receive path 3_{2R} includes an antenna function 3-1_{R}, which typically employs the antenna of FIG. 14, a filter function 3-2_{R}, an amplifier function 3-3_{R}, a filter function 3-4_{R} and a mixer function 3-5_{R}. The antenna function 3-1_{R} is for converting between received radiation and electronic signals, the filter function 3-2_{R} is for limiting signals within an operating frequency band for the receive signals, the amplifier function 3-3_{R} is for boosting receive signal power, the filter function 3-4_{R} is for limiting signals within the operating frequency receive band, and the mixer function 3-5_{R} is for shifting frequencies between RF receive signals and lower frequencies.

The transmit path 3_{2R} includes a mixer function 3-5_{T}, a filter function 3-4_{T}, an amplifier function 3-3_{T}, a filter function 3-2_{T}, and an antenna function 3-1_{T} which typically employs the antenna of FIG. 15. The mixer function 3-5_{T} is for shifting frequencies between lower frequencies and RF transmit signals, the filter function 3-4_{T} is for limiting signals within the operating frequency transmit band, the amplifier function 3-3_{T} is for boosting transmit signal power, the filter function 3-2_{T} is for limiting signals within operating frequency band for the transmit signals, and the antenna function 3-1_{T} is for converting between electronic signals and the transmitted radiation.

In FIG. 26, the RF front-end functions are connected by junctions. The junction P¹_{R} is between antenna function 3-1_{TR} and filter functions 3-2_{R}, the junction P²_{R} is between filter function 3-2_{R} and the amplifier function 3-3_{R}, the junction P³_{R} is between amplifier function 3-3_{R} and filter function 3-4_{R} and the junction P⁴_{R} is between filter function 3-4_{R} and mixer function 3-5_{R}. The junction P¹_{T} is between antenna function 3-1_{T} and filter functions 3-2_{T}, the junction P²_{T} is between filter function 3-2_{T} and the amplifier function 3-3_{T}, the junction P³_{T} is between amplifier function 3-3_{T} and filter function 3-4_{T} and the junction P⁴_{T} is between filter function 3-4_{T} and mixer function 3-5_{T}.

In the embodiment of FIG. 26, the junctions P¹_{R}, P²_{R}, P³_{R} and P⁴_{R} correspond to ports of the filter 3-2_{R} amplifier 3-3_{R}, filter 3-4_{R} and mixer 3-5_{R} components and the junctions P⁴_{T}, P³_{T}, P²_{T} and P²_{T} correspond to ports of mixer 3-5_{T}, filter 3-4_{T}, amplifier 3-3_{T} and filter 3-4_{T} components.

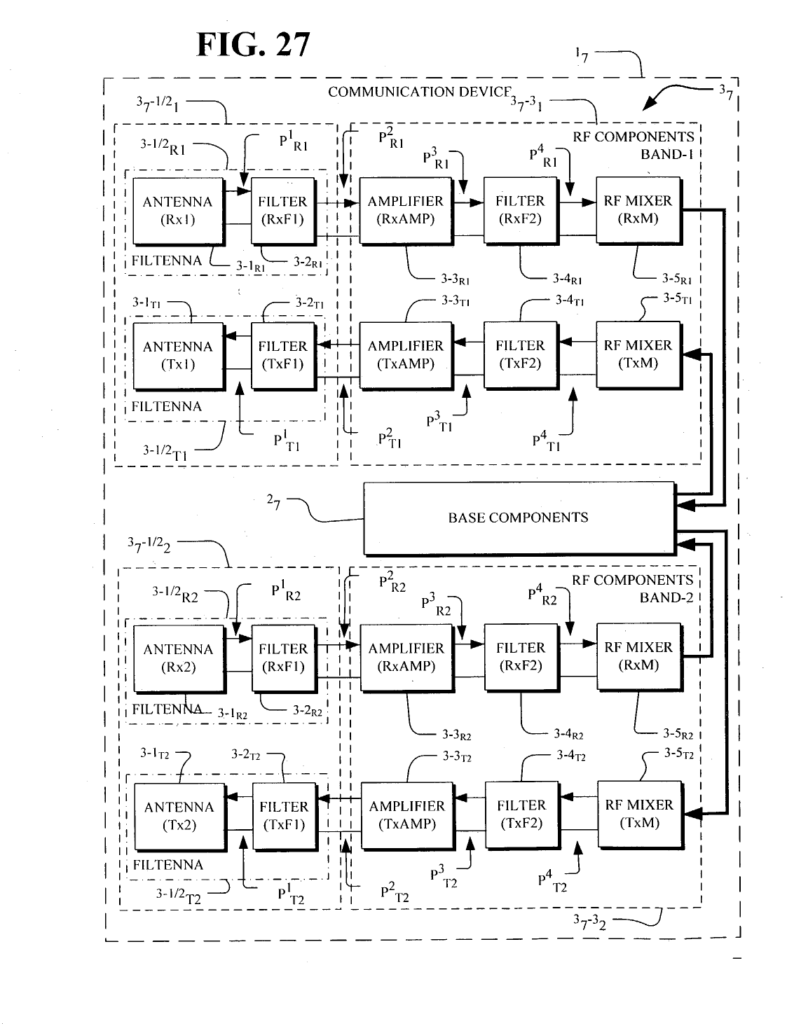

FIG. 27 depicts a schematic view of a small communication device 1₇, as another embodiment of the communication device 1₁ of FIG. 1, with base components 2₇ and RF front-end components 3₇. The front-end components 3₇ include front-end components 3₇-1/2₁, front-end components 3₇-1/2₂, front-end components 3₇-3₁ and front-end components 3₇-3₂. The RF components 3₇ perform the RF front-end functions as described in connection with FIG. 1 for two different bands, Band-1 and Band-2. Each band has separate filtenna components. Band-1 includes filtenna components 3₇-1/2₁ and front-end components 3₇-3₁. Band-2 includes filtenna component 3₇-1/2₂ and front-end components 3₇-3₂. Both Band-1 and Band-2 have a receive path and a transmit path.

For Band-1, the receive path includes an antenna function 3-1_{R1}, a filter function 3-2_{R1}, an amplifier function 3-3_{R1}, a filter function 3-4_{R1} and a mixer function 3-5_{R1}. The antenna function 3-1_{R1} is for converting between radiated and electronic signals, the filter function 3-2_{R1} is for limiting signals within operating frequency band for the receive signals, the amplifier function 3-3_{R1} is for boosting receive signal power, the filter function 3-4_{R1} is for limiting signals within the operating frequency receive band, and the mixer function 3-5_{R1} is for shifting frequencies between RF receive signals and lower frequencies. For Band-1, the transmit path includes an antenna function 3-1_{T1}, a filter function 3-2_{T1}, an amplifier function 3-3_{T1}, a filter function 3-4_{T1} and a mixer function 3-5_{T1} The antenna function 3-1_{R1} is for converting between radiated and electronic signals, the filter function 3-2_{T1} is for limiting signals within operating frequency band for the transmit signals, the amplifier function 3-3_{T1} is for boosting transmit signal power, the filter function 3-4_{T1} is for limiting signals within the operating frequency transmit band, and the mixer function 3-5_{T1} is for shifting frequencies between RF transmit signals and lower frequencies.

For Band-2, a receive path and a transmit path are present. The receive path includes an antenna function 3-1_{R2}, a filter function 3-2_{R2}, an amplifier function 3-3_{R2}, a filter function 3-4_{R2} and a mixer function 3-5_{R2}. The antenna function 3-1_{R2} is for converting between radiated and electronic signals, the filter function 3-2_{R2} is for limiting signals within operating frequency band for the receive signals, the amplifier function 3-3_{R2} is for boosting receive signal power, the filter function 3-4_{R2} is for limiting signals within the operating frequency receive band, and the mixer function 3-5_{R2} is for shifting frequencies between RF receive signals and lower frequencies. For Band-2, the transmit path includes an antenna function 3-1_{T2}, a filter function 3-2_{T2}, an amplifier function 3-3_{T2} a filter function 3-4_{T2} and a mixer function 3-5_{T2}. The antenna function 3-1_{T2} is for converting between radiated and electronic signals, the filter function 3-2_{T2} is for limiting signals within operating frequency band for the transmit signals, the amplifier function 3-3_{T2} is for boosting transmit signal power, the filter function 3-4_{T2} is for limiting signals within the operating frequency transmit band, and the mixer function 3-5_{T2} is for shifting frequencies between RF transmit signals and lower frequencies.

In FIG. 27, for Band-1 and Band-2, the front-end RF functions are connected by physical or logical junctions. For Band-1 for the receive path, the junctions P²_{R1}, P³_{R1} and P⁴_{R1} are located at physical ports of physical amplifier 3-3_{R1}, filter 3-4_{R1} and mixer 3-5_{R1} and the junctions P⁴_{T1}, P³_{T1} and P²_{T1}, are located at physical ports of physical mixer 3-5_{T1}, filter 3-4_{T1} and amplifier 3-3_{T1}. The antenna function 3-1_{R1} and the filter functions 3-2_{R1} are integrated into a common integrated component, filtenna 3-1/2_{R1} so that the P¹_{R1} logical junction parameters are integrated and not separately tuned. The parameters for junction P²_{R1} are tuned for the combined antenna function 3-1_{R1} and the filter function 3-2_{R1}. The integrated filter and antenna of the filtenna component 3-1/2_{R1} are characterized by the junction properties at the port having parameters for junction P²_{R1}. In particular, the junction impedance or other parameters which may exist at the P¹_{R1} logical junction are not tuned to provide standard values, such as a 50 ohm matching impedance, but are permitted to assume values dependent on the desired values for junction parameters at the P²_{R2} physical junction.

For Band-1 for the transmit path, the junctions P²_{T1}, P³_{T1} and P⁴_{T1} are located at physical ports of physical amplifier 3-3_{T1}, filter 3-4_{T1} and mixer 3-5_{T1} and the junctions P⁴_{T1, P}³_{T1} and P²_{T1} are located at physical ports of physical mixer 3-5_{T1}, filter 3-4^{T1} and amplifier 3-3_{T1}. The antenna function 3-1_{T1} and the filter functions 3-2T, are integrated into a common integrated component, filtenna 3-1/2_{T1} so that the P¹_{T1} logical junction parameters are integrated and not separately tuned. The parameters for junction P²_{T1} are tuned for the combined antenna function 3-1_{T1} and the filter function 3-2^{T1}. The integrated filter and antenna of the filtenna component 3-1/2_{T1} are characterized by the junction properties at the port having parameters for junction P²_{T1}. In particular, the junction impedance or other parameters which may exist at the P¹_{T1} logical junction are not tuned to provide standard values, such as a 50 ohm matching impedance, but are permitted to assume values dependent on the desired values for junction parameters at the P²_{T2} physical junction.

For Band-2 for the receive path, the junctions P²R₂, P³R₂ and P⁴_{R2} are located at physical ports of physical amplifier 3-3_{R2}, filter 3-4_{R2} and mixer 3-5_{R2} and the junctions P⁴_{T1}, P³_{T1} and P²_{T1} are located at physical ports of physical mixer 3-5_{T1}, filter 3-4_{T1} and amplifier 3-3_{T1}. The antenna function 3-1_{R2} and the filter functions 3-2_{R2} are integrated into a common integrated component, filtenna 3-1/2_{R2} so that the P¹_{R2} logical junction parameters are integrated and not separately tuned. The parameters for junction P²R₂ are tuned for the combined antenna function 3-1R₂ and the filter function 3-2R₂, The integrated filter and antenna of the filtenna component 3-1/2R₂ are characterized by the junction properties at the port having parameters for junction P²R₂ In particular, the junction impedance or other parameters which may exist at the P¹_{R2} logical junction are not tuned to provide standard values, such as a 50 ohm matching impedance, but are permitted to assume values dependent on the desired values for junction parameters at the P²R₂ physical junction.

For Band-2 for the transmit path, the junctions P²_{T2}, P³_{T2} and P⁴_{T2} are located at physical ports of physical amplifier 3-3_{T2}, filter 3-4_{T2} and mixer 3-5_{T2} and the junctions P⁴_{T2}, P³_{T2} and P²_{T2} are located at physical ports of physical mixer 3-5_{T2}, filter 3-4_{T2} and amplifier 3-3_{T2}. The antenna function 3-1_{T2} and the filter functions 3-2_{T2} are integrated into a common integrated component, filtenna 3-1/2_{T2} so that the P¹_{T2} logical junction parameters are integrated and not separately tuned. The parameters for junction P²_{T2} are tuned for the combined antenna function 3-1_{T2} and the filter function 3-2_{T2}. The integrated filter and antenna of the filtenna component 3-1/2_{T2} are characterized by the junction properties at the port having parameters for junction P²_{T2}. In particular, the junction impedance or other parameters which may exist at the P¹_{T2} logical junction are not tuned to provide standard values, such as a 50 ohm matching impedance, but are permitted to assume values dependent on the desired values for junction parameters at the P²_{T2} physical junction.

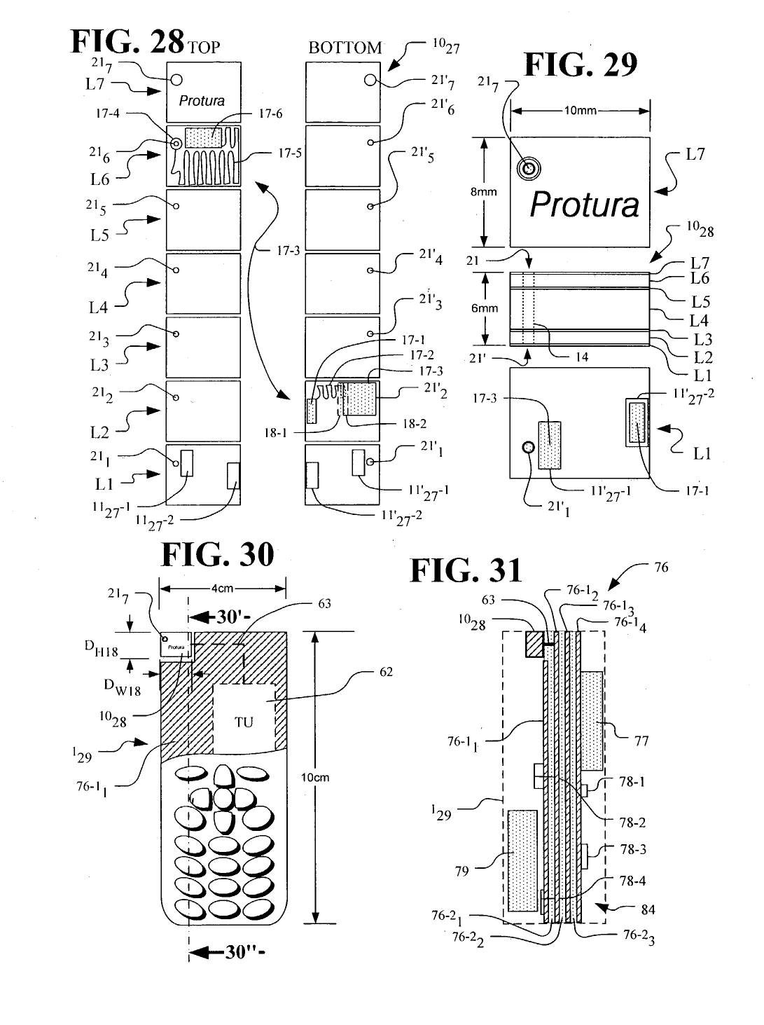

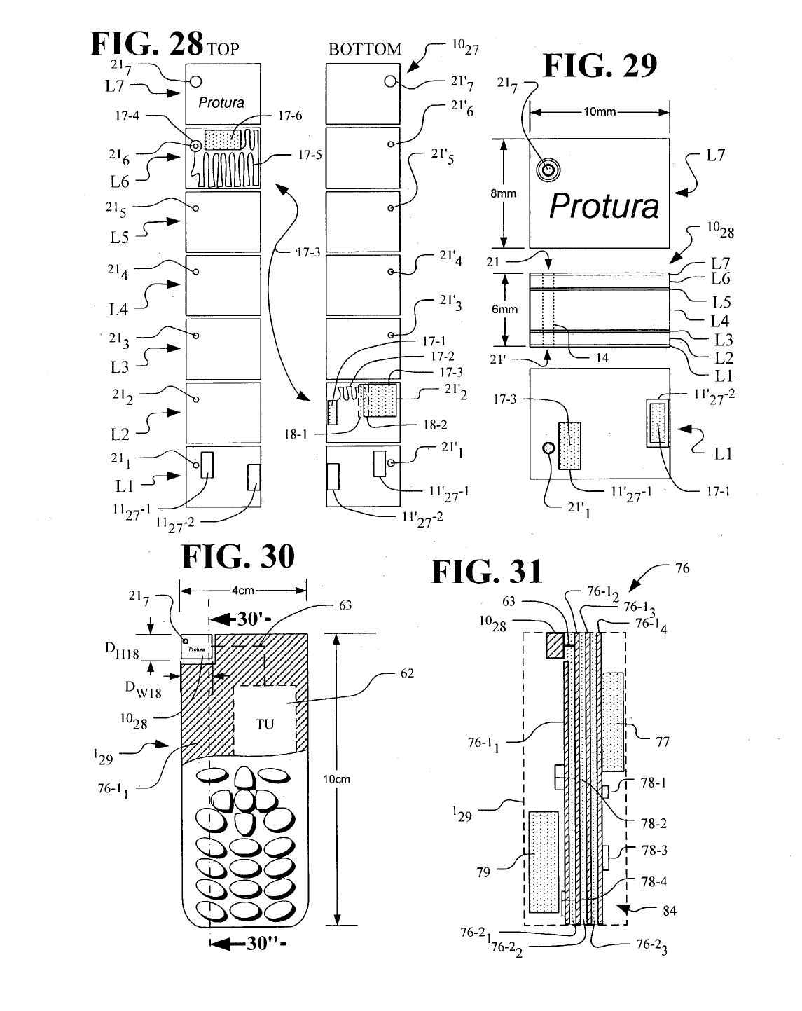

FIG. 28 depicts a top view and bottom view of unstacked layers L1, L2, . . . , L7, lying in a base plane (the plane of the drawing), for an antenna 10₂₇. In FIG. 28, each of the layers L1, L2, . . . , L7 has a TOP portion (top view) and a BOTTOM portion (bottom view).

All of the layers L1, L2, . . . , L7 have openings 21 on the TOP side including openings 21₁, 21₂, . . . , 21₇ connecting through to openings 21′ on the BOTTOM side including openings 21′₁, 21′₂, . . . , 21′₇. All of the openings 21₁, 21₂, . . . , 21₇ and openings 21′₁, 21′₂, . . . , 21′₇ are positioned so that they can be aligned in the finally assembled antenna (see FIG. 29) to provide a co-linear, through-layer connection from the layer L1 through each of the intermediate layers L2, . . . , L6 to layer L7. The finally assembled antenna (see FIG. 29) has layer L7 over layer L6 over layer L5 over layer L4 over layer L3 over layer L2 over layer L1 with all layers adhered together with all of the openings 21₁, 21₂, . . . , 21₇ and openings 21′₁, 21₂, . . . , 21₇ axially aligned. Typically, the openings 21 and 21′ are 0.64 mm in diameter.

The layer L1 of antenna 10₂₇ is a mask layer with openings 11₂₇-1, 11₂₇-2 and 21₁ on the TOP and corresponding openings 11′₂₇-1, 11′₂₇-2 and 21′₁ on the BOTTOM. The openings 11₂₇-2 and 11′₂₇-2 are aligned in the finally assembled antenna (see FIG. 29) and enable external contact to one end of the radiation element. The openings 11₂₇-1 and 11′₂₇-1 are aligned when assembled (see FIG. 29) to provide access to patch 17-3 to facilitate physically attaching the antenna 10₂₇ at a second point to a circuit board (see FIG. 31).

The layer L2 includes, on the TOP, the opening 21₂ and includes, on the BOTTOM, the opening 21′₂ and a section of the radiation element 17 including connection pad 17-1, a trace 17-2 and a patch 17-3. The trace 17-2 is formed of conducting segments that turn back and forth in many directions to establish an electrical length while compressing the area and volume of the antenna. The trace 17-2 can be regular or irregular in shape and is typically formed on a substrate using conventional printed circuit technology. The connection pad 17-1, trace 17-2 and patch 17-3 are electrically connected to each other and are electrically connected by a through-layer connection through opening 21′₂.

The layers L3, L4 and L5 include, on the TOP, the openings 21₃, 21₄ and 21₅ and include, on the BOTTOM, the openings 21′₃, 21′₄ and 21′₅. These openings provide for a through-layer connection 14 in the finally assembled antenna (see FIG. 29) from the patch 17-3 of layer L2 to connection pad 17-4 on layer L6. The layers L3 and L5 are pregnated separators. When the uncompressed antenna 10₂₇ of FIG. 28 is compressed into the final antenna 10₂₈ of FIG. 29, all the layers L1, L2, . . . , L7 are adhered together by the layers L3 and L5.

The layer L6 includes, on the TOP, the opening 21₆ and a section of the radiation element 17 including connection pad 17-4, trace 17-5 and patch 17-6 and includes on the BOTTOM, the opening 21′₆. The connection pad 17-4, trace 17-5 and patch 17-6 are electrically connected to each other and are electrically connected by the through-layer connection 14 (see FIG. 29) through opening 21₆ and opening 21′₆ through layers L5, L4 and L3 to the section of the radiation element on Layer L2 including patch 17-3, trace 17-2 and connection pad 17-1.

The layer L7 is a silk screen layer holding identifying data such as a logo “Protura” and other information that may be desired.

The radiation element 17 includes the series connection of connection pad 17-1, the trace 17-2, the patch 17-3, through-layer connection 14, connection pad 17-4, trace 17-5 and patch 17-6. The length, width, thickness, position and other attributes of all of the components of radiation element 17 combine to establish the electrical and radiation properties of element 17.

In FIG. 28, the patch 17-3 on layer L2 is adjusted in size to tune the high band (GSM1800, GSM1900) and the patch 17-6 on layer L6 is adjusted in size to tune the low band (GSM900). For example, if patch 17-3 is widened as shown at 18-1, more of the trace 17-2 is covered or if patch 17-3 is shortened as shown at 18-2, less of the trace 17-2 is covered. Such small adjustments in size are effective to make small adjustments in the antenna parameters, particularly the frequency band.

In FIG. 29, all of the layers L1, L2, . . . , L7 of FIG. 28 are shown finally assembled with all layers adhered together to form compressed antenna 10₂₈ in a volume. The compressed antenna 10₂₈ has approximate dimensions that are a width of 8 mm, a length of 10 mm and a height of 6 mm. The layers are superimposed with L7 over layer L6 over layer L5 over layer L4 over layer L3 over layer L2 over layer L1 with the openings 21 on the TOP side and the openings 21′ on the BOTTOM side coaxially aligned to provide the through-layer connection 14 from the layer L1 through each of the intermediate layers L2, . . . , L6 to layer L7. Through-layer connection 14 is established using standard circuit board processing steps. The processing steps include, in one example, assembling the compressed together with openings 21 and 21′ coaxially aligned. Sputtering is then performed to seed the openings with a conductive path. Finally, the through-layer connection 14 is completed by electroplating or other conventional circuit board technology.

In FIG. 29, the layer L1 is shown in the bottom view of antenna 10₂₈, with the openings 11′₂₇-1, 11′₂₇-2 and 21′₁. These openings expose in FIG. 29 the connection pad 17-1 and a portion of the patch 17-3, both being on the BOTTOM of layer L2. Solder or other connections are made between the connection pad 17-1 and patch 17-3 to a circuit board in a communication device (see FIG. 31). These connections function to connect the antenna 1028 to a circuit board both electrically and mechanically.

In FIG. 30, a communication device 1₂₉ is shown partially cut-away and representing a cell phone, pager or other similar communication device that can be used in close proximity to people. The communication device 1₂₉ includes an antenna area allocated for antenna 10₂₈ of FIG. 29 which is offset from the ground plane 76-1₁. The antenna 10₂₈ receives and transmits radio wave radiation for the communication device 1₂₉. In FIG. 30, the antenna area is slightly larger than the width D_{W29} and length D_{L29} of antenna 10₂₈. In one embodiment, the antenna 10₂₈ has a clearance distance from the ground plane of approximately 1 mm on the right and 3 mm on the bottom with no ground plane on the top and left. A section line 30′-30″ extends from top to bottom of the communication device 12₉.

In FIG. 30, the compressed antenna 10₂₈ operates in allocated frequency spectrums around the world including those of North America, South America, Europe, Asia and Australia. The cellular frequencies are used when the communication device 1₂₉ is a mobile phone, PDA, portable computer, telemetering equipment or any other wireless device. The antenna 10₂₈ operates to transmit and/or receive as a tri-band device in frequency bands GSM900, GSM1800 and GSM1900. In other embodiments, compressed antennas operate to transmit and/or receive in allocated frequency bands, for example, anywhere from 800 MHz to 2500 MHz.

In FIG. 31, the communication device 1₂₉ of FIG. 30 is shown in a schematic, cross-sectional, end view taken along the section line 30′-30″ of FIG. 30. In FIG. 31, a circuit board 76 includes, by way of example, an outer conducting layer 76-1₁, internal conducting layers 76-1₂ and 76-1₃, internal insulating layers 76-2₁, 76-2₂ and 76-2₃, and another outer conducting layer 76-1₄. In one example, the layer 76-1₁ is a ground plane. The printed circuit board 76 supports the electronic components associated with the communication device 12₉ including a display 77 and miscellaneous components 78-1, 78-2, 78-3 and 78-4 which are shown as representative of many components. Communication device 1₂₉ also includes a battery 79. The antenna 10₂₈ is mounted or otherwise coupled to the multi-layered printed circuit board 76 by solder or other convenient connection means and has, for example, a connection 63 from the antenna 10₂₈ to components (such as 78-1, 78-2, 78-3 and 78-4) that form the transceiver unit 62 of FIG. 30.

While the invention has been particularly shown and described with reference to preferred embodiments thereof it will be understood by those skilled in the art that various changes in form and details may be made therein without departing from the scope of the invention.

1. (Original) An antenna, for use with a communication device operating for exchanging energy in one or more bands of radiation frequencies, comprising,
a radiation element for operating in said one or more bands, said radiation element including,
a plurality of conducting segments electrically connected to exchange energy in said one or more bands of radiation frequencies,
said segments arrayed in a compressed pattern,
said compressed pattern extending in three dimensions to fill a volume with segments superimposed in the volume to reduce the size of a projection of the antenna on a base plane of the volume.

2. (Original) The antenna of claim 1 wherein said radiation element is deployed on a flexible substrate and said radiation element and said substrate are folded to fit within said volume.

3. (Original) The antenna of claim 1 wherein said radiation element is deployed in regions having sections of the radiation element and is deployed on a flexible substrate where said element and said substrate are folded to fit within said volume and wherein said sections are separated by dielectric spacers.

4. (Original) The antenna of claim 1 wherein said radiation element is arrayed to form a loop.

5. (Original) The antenna of claim 1 wherein said radiation element is arrayed to form a stub.

6. (Original) The antenna of claim 1 wherein said radiation element includes one or more connection pads for electrical connection of the radiation element to RF components of said communication device and wherein said radiation element and said one or more connection pads are arrayed on the same substrate.

7. (Original) The antenna of claim 1 wherein said radiation element terminates in one or more connection pads for surface mounting one or more connection pads to a circuit board.

8. (Original) The antenna of claim 1 wherein said bands include a US PCS band operating from 1850 MHz to 1990 MHz, a European DCS band operating from 1710 MHz to 1880 MHz, a European GSM band operating from 880 MHz to 960 MHz and a US cellular band operating from 829 MHz to 896 MHz.

9. (Original) The antenna of claim 1 wherein said radiation element is deployed on a substrate having one or more layers superimposed to fit within said volume.

10. (Original) The antenna of claim 1 wherein said radiation element is formed by electrically connected sections with each section having electrically connected conducting segments.

11. (Original) The antenna of claim 10 wherein said sections are deployed on one side of a common substrate.

12. (Original) The antenna of claim 11 wherein said radiation element is a loop.

13. (Original) The antenna of claim 10 wherein said sections are deployed on both sides of a common substrate.

14. (Original) The antenna of claim 1 wherein said segments are arrayed in multiple divergent directions not parallel to an orthogonal coordinate system so as to provide a long antenna electrical length while permitting the overall outside dimensions of said antenna to fit within said volume.

15. (Original) The antenna of claim 1 wherein said radiation element includes one or more connection pads for coupling to a transceiver unit of said communication device and for connection to another radiation element.

16. (Original) The antenna of claim 1 wherein said radiation element has an irregular shape and wherein said segments are arrayed in an irregular three-dimensional compressed pattern.

17. (Original) The antenna of claim 1 wherein said radiation elements transmit and receive radiation.

18. (Original) The antenna of claim 1 wherein said radiation element transmits and receives in the US PCS band operating from 1850 MHz to 1990 MHz.

19. (Original) The antenna of claim 1 wherein said radiation element transmits and receives in a European DCS band operating from 1710 MHz to 1880 MHz.

20. (Original) The antenna of claim 1 wherein said radiation element transmits and receives in a European GSM band operating from 880 MHz to 960 MHz.

21. (Original) The antenna of claim 1 wherein said radiation element transmits and receives in a US cellular band operating from 829 MHz to 896 MHz.

22. (Original) The antenna of claim 1 wherein said radiation element transmits and receives in mobile telephone frequency bands anywhere from 800 MHz to 2500 MHz.

23. (Original) The antenna of claim 1 wherein said radiation element is on a first layer mounted on dielectric material and where another radiation element is on a second layer mounted on dielectric material where said first and second layers are juxtaposed.

24. (Original) The antenna of claim 1 wherein said radiation element provides multi-band performance.

25. (Original) The antenna of claim 1 wherein said radiation element is deployed in sections on different layers of dielectric material and where said layers are superimposed with through-layer connections to electrically connect said sections.

26. (Original) The antenna of claim 25 wherein each of said layers of dielectric material have a an opening and where said layers are superimposed with said openings in alignment and where a through-layer connection connects through said openings to electrically connect said sections.

27. (Original) The antenna of claim 25 wherein said sections include connection pads, traces and patches electrically connected.

28. (Original) The antenna of claim 27 wherein said patches overlay portions of said traces to tune a frequency band of the antenna.

29. (Original) The antenna of claim 25 wherein a first one of said sections includes a first connection pad, a first trace and a first patch electrically connected wherein said first patch overlays a portion of said first trace to tune a first frequency band of the antenna and wherein a second one of said sections includes a second connection pad, a second trace and a second patch electrically connected wherein said second patch overlays a portion of said second trace to tune a second frequency band of the antenna.

30. (Original) The antenna of claim 29 wherein said antenna is a tri-band device.

31. (Original) The antenna of claim 30 wherein said bands include GSM900, GSM 1800 and GSM 1900.

32. (Original) The antenna of claim 31 wherein said first patch is for tuning said GSM900 band and wherein said second patch is for tuning said GSM1800 band and said GSM1900 band.

33. (Original) The antenna of claim 25 wherein said antenna has a bottom layer that exposes one or more connection pads for surface mounting to a circuit board of said communication device.

34. (Original) The antenna of claim 33 wherein said circuit board includes a ground plane and said antenna bottom layer is offset from said ground plane by a clearance distance.

35. (Original) The antenna of claim 34 wherein said clearance distance is at least 1 mm.

36. (Original) The antenna of claim 25 wherein said antenna has a bottom layer that exposes one connection pad for surface mounting to a circuit board at a first location to electrically connect to a transceiver unit of said communication device.

37. (Original) The antenna of claim 36 wherein said bottom layer exposes a connection pad for surface mounting to said circuit board at a second location whereby said antenna is mechanically connected to the circuit board at two locations.

38. (Original) The antenna of claim 25 wherein said radiation element provides multi-band performance.

39. (Original) The antenna of claim 38 wherein said performance includes GSM900, GSM 1800 and GSM 1900 bands.

40. (Original) An antenna, for use with a communication device having a ground plane and operating for exchanging energy in one or more bands of radiation frequencies, comprising,
a radiation element including,
a plurality of electrically conducting segments connected to exchange energy in one or more of said bands of radiation frequencies,
said compressed pattern extending in three dimensions to fill a volume with segments superimposed in the volume to reduce the size of a projection of the antenna on a base plane of the volume,
said radiation element deployed in sections on different layers of dielectric material, each of said layers of dielectric material having an opening, where said layers are superimposed to align said openings coaxially and where a through-layer connection connects through said openings to electrically connect said sections.

41. (Original) The antenna of claim 40 wherein said sections include connection pads, traces and patches electrically connected.

42. (Original) The antenna of claim 41 wherein said patches overlay portions of said traces to tune a frequency band of the antenna.

43. (Original) The antenna of claim 40 wherein a first one of said sections includes a first connection pad, a first trace and a first patch electrically connected wherein said first patch overlays a portion of said first trace to tune a first frequency band of the antenna and wherein a second one of said sections includes a second connection pad, a second trace and a second patch electrically connected wherein said second patch overlays a portion of said second trace to tune a second frequency band of the antenna.

44. (Original) The antenna of claim 43 wherein said antenna is a tri-band device.

45. (Original) The antenna of claim 44 wherein said bands include GSM900, GSM 1800 and GSM 1900.

46. (Original) The antenna of claim 43 wherein said first patch is for tuning said GSM900 band and wherein said second patch is for tuning said GSM1800 band and said GSM1900 band.

47. (Original) Antennas for a communication device having a ground plane operating for exchanging energy in one or more bands of radiation frequencies, comprising,
a first radiation element including,
a plurality of electrically conducting segments connected to exchange energy in one or more of said bands of radiation frequencies,
said compressed pattern extending in three dimensions to fill a volume with segments superimposed in the volume to reduce the size of a projection of the antenna on a base plane of the volume,
said first radiation element deployed in sections on different layers of dielectric material, each of said layers of dielectric material having an opening, where said layers are superimposed to align said openings coaxially and where a through-layer connection connects through said openings to electrically connect said sections,
a second radiation element connected to exchange energy in one or more of said bands of radiation frequencies.

48. (Original) The antennas of claim 47 wherein said first radiation element operates to receive energy in a first one of said bands and wherein said second radiation element operates to transmit energy in said first one of said bands.
